(19) United States
(12) Patent Application Publication
(10) Pub. No.: US 2016/0340538 A1
(43) Pub. Date: Nov. 24, 2016

(54) GOLF BALL

(71) Applicant: Bridgestone Sports Co., Ltd., Tokyo (JP)

(72) Inventors: Takanori TAGO, Chichibushi (JP); Atsushi NANBA, Chichibushi (JP)

(73) Assignee: Bridgestone Sports Co., Ltd., Tokyo (JP)

(21) Appl. No.: 15/093,964

(22) Filed: Apr. 8, 2016

(30) Foreign Application Priority Data
May 22, 2015 (JP) 2015-104388

(51) Int. Cl. C09D 123/08; A63B 37/00; C08J 7/04

(52) U.S. Cl. CPC C09D 123/0869; C08J 7/047; A63B 37/0023; C08J 2309/00; C08J 2423/08

(57) ABSTRACT

In a golf ball having a core of at least one layer and a cover of at least one layer, some or all of the surface of at least one such layer of the ball is treated with a treatment solution. The treatment solution is made of (A) a polyolefin-based thermoplastic resin and (B) at least one solvent selected from the group consisting of water, ammonia water and organic solvents, and is obtained by dissolving or finely dispersing resin solids of component A in the solvent of component B. The golf ball has an improved adhesion between the layers, enabling the durability of the ball to cracking on impact to be increased.

### CROSS-REFERENCE TO RELATED APPLICATION

This non-provisional application claims priority under 35 U.S.C. §119(a) on Patent Application No. 2015-104388 filed in Japan on May 22, 2015, the entire contents of which are hereby incorporated by reference.

### TECHNICAL FIELD

The present invention relates to a golf hall having a core of at least one layer and a cover of at least one layer. More particularly, the invention relates to a golf ball in which adhesion between the layers of the ball is improved, enabling the durability of the golf ball to cracking on impact to be increased.

### BACKGROUND ART

Solid golf balls with a multilayer construction of three or more pieces have come into frequent use in recent years, and even four-piece solid golf balls composed of a core encased by a cover of three or more layers, such as an envelope layer, an intermediate layer and an outermost layer, have made it onto the market. These multilayer golf balls are generally obtained by successively injection-molding synthetic resin cover materials around the core periphery so as to form a succession of layers over the core. However, when adhesion between the layers of the golf ball is poor, this may invite declines in various ball properties, such as the distance, spin rate on approach shots, feel at impact and durability to cracking. Hence, there exists a desire to improve adhesion between the layers.

In this specification, the terms ‘piece’ and ‘layer’ are used interchangeably to refer to the parts of a golf ball. For example, a golf ball constructed of a one-layer core surrounded by, in order, an envelope layer, an intermediate layer and an outermost cover layer may be referred to either as a “four-piece ball” or a “four-layer ball.”

Art for improving adhesion between the layers of a golf ball includes that described in the following patent publications.

JP-A 10-179795 discloses art in which a layer of adhesive is formed on the intermediate layer. JP-A 11-137726 teaches art that blends an adhesive into a cover material composed primarily of a thermoplastic resin. JP-A 2003-339912 describes art wherein the surface of the inner layer in a cover having an inner layer and an outer layer is acid-washed, thereby improving adhesion between the inner layer which is made of an ionomer resin and the outer layer which is made of a non-ionomeric resin such as a polyurethane elastomer. Finally, JP-A 2009-131631 discloses a golf ball manufacturing method wherein, to improve adhesion between a rubber core and a urethane cover, the surface of the rubber core is treated with a solution containing a haloisocyanuric acid and/or a metal salt thereof, following which the treated core is encased with the cover material.

However, depending on the materials of which the individual layers are made, adhesion remains inadequate even in the foregoing prior art. Adhesion is particularly inadequate between a rubber core and an ionomer-based resin material, with decreases in such adhesion having an adverse effect on various properties of the golf ball.

### SUMMARY OF INVENTION

It is therefore an object of this invention to provide a golf ball in which adhesion between the layers is improved, enabling various properties of the golf ball to be enhanced, particularly the durability to cracking on impact.

As a result of extensive investigations, we have discovered that, in a golf ball having a core of at least one layer and a cover of at least one layer, by treating some or all of the surface of at least one such layer of the ball with a treatment solution which contains (A) a polyolefin-type thermoplastic resin and (B) at least one solvent selected from the group consisting of water, ammonia water and organic solvents and is obtained by dissolving or finely dispersing the resin of component A in the solvent of component B, and then encasing the treated layer with an adjoining layer, adhesion between the treated layer and the layer adjoining the treated layer can be increased, enabling a high durability on impact to be obtained. When the surface of the layer to be treated is abraded, minute irregularities typically form on the surface. What most likely happens is that the treatment solution containing components A and B makes its way into the tiny irregularities on the abraded surface, thereby improving adhesion with the adjoining layer covering the surface of the treated layer.

Accordingly, the invention provides a golf ball that has a core of at least one layer and a cover of at least one layer, wherein some or all of a surface of at least one such layer of the ball is treated with a treatment solution. The treatment solution includes (A) a polyolefin-based thermoplastic resin and (B) at least one solvent selected from the group consisting of water, ammonia water and organic solvents, and is obtained by dissolving or finely dispersing resin solids of component A in the solvent of component B.

Preferably, the thermoplastic resin of component A is at least one resin selected from the group consisting of:

(a-1) copolymers of an olefin and an α,β-unsaturated carboxylic acid of 3 to 8 carbon atoms,

(a-2) ionomer resins consisting of a metal ion neutralization product of a copolymer of an olefin and an α,β-unsaturated carboxylic acid of 3 to 8 carbon atoms,

(a-3) terpolymers of an olefin, an α,β-unsaturated carboxylic acid of 3 to 8 carbon atoms and an α,β-unsaturated. carboxylic acid ester, and

(a-4) ionomer resins consisting of a metal ion neutralization product of a terpolymer of an olefin, an α,β-unsaturated carboxylic acid of 3 to 8 carbon atoms and an α,β-unsaturated carboxylic acid ester.

Preferably, the thermoplastic resin of component A is finely dispersed in the solvent of component B, and the finely dispersed component A resin has a particle size of not more than 10 μm.

The treatment solution typically has a pH of at least 7.5.

In a preferred embodiment of the golf ball of the invention, the layer treated with the treatment solution or a layer adjoining the treated layer is formed of a material molded under heat from a rubber composition containing: (I) a base rubber, (II) an organic peroxide, and (III) water and/or a metal monocarboxylate.

In another preferred embodiment, the layer treated with the treatment solution or a layer adjoining the treated layer is formed primarily of a material obtained by blending as essential components:
100 parts by weight of a resin component made of, in admixture,

(e) a base resin of (e-1) an olefin-unsaturated carboxylic acid random copolymer and/or a metal ion neutralization product of an olefin-unsaturated carboxylic acid random copolymer mixed with (e-2) an olefin-unsaturated carboxylic acid-unsaturated carboxylic acid ester random terpolymer and/or a metal ion neutralization product of an olefin-unsaturated carboxylic acid-unsaturated carboxylic acid ester random terpolymer in a weight ratio between 100:0 and 0:100, and

(f) a non-ionomeric thermoplastic elastomer in a weight ratio between 100:0 and 50:50;

(g) from 5 to 120 parts by weight of a fatty acid and/or fatty acid derivative having a molecular weight of from 228 to 1,500; and

(h) from 0.1 to 17 parts by weight of a basic inorganic metal compound capable of neutralizing un-neutralized acid groups in the base resin and component (g).

In the inventive golf ball, the layer treated with the treatment solution and the layer adjoining the treated layer have a bond strength therebetween of preferably at least 1.10 N/4 mm.

In the inventive golf ball, the organic solvent (b-3) is preferably a polar solvent. This organic solvent (b-3) may be selected from the group consisting of methanol, ethanol, n-propanol, isopropyl alcohol, acetone, tetrahydrofuran, ethylene glycol, dioxane, methyl ethyl ketone, acetic acid, ethyl acetate and chloroform.

The treatment solution typically has a concentration of component A resin solids of from 0.1 to 50 wt %.

In the golf ball of the invention, adhesion between the layers of the ball can be improved, enabling the durability of the ball to cracking on impact to be increased.

### DESCRIPTION OF THE DIAGRAMS

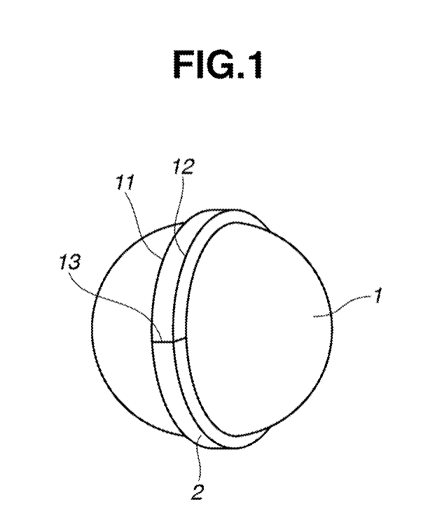

FIG. 1 is a diagram depicting a method of obtaining a test specimen for measuring the bond strength between the core and the envelope layer of a golf ball.

### DESCRIPTION OF THE PREFERRED EMBODIMENTS

The objects, features and advantages of the invention will become more apparent from the following detailed description, taken in conjunction with the foregoing diagrams.

The golf ball of the invention includes a core of at least one layer and a cover of at least one layer.

The core can be formed using a known rubber composition. Although not particularly limited, preferred examples include rubber compositions formulated as described below.

The material forming the core may be composed primarily of a rubber material. For example, the core may be formed using a rubber composition which includes, together with a base rubber, such ingredients as a co-crosslinking agent, an organic peroxide, an inert filler, sulfur, an antioxidant and an organosulfur compound.

The use of polybutadiene as the base rubber of the rubber composition is preferred. The polybutadiene is preferably one having a cis-1,4 bond content on the polymer chain of at least 80 wt %, more preferably at least 90 wt %, and even more preferably at least 95 wt %. At a content of cis-1,4 bonds among the bonds on the polybutadiene molecule which is too low, the resilience may decrease. The polybutadiene has a content of 1,2-vinyl bonds on the polymer chain of preferably not more than 2%, more preferably not more than 1.7%, and even more preferably not more than 1.5%. At a 1,2-vinyl bond content which is too high, the resilience may decrease.

To obtain a molded and vulcanized rubber composition having a good resilience, the polybutadiene included is preferably one synthesized with a rare-earth catalyst or a group VIII metal compound catalyst. Polybutadiene synthesized with a rare-earth catalyst is especially preferred.

Rubber components other than the above polybutadiene may be included in the rubber composition, insofar as the objects of the invention are attainable. Illustrative examples of rubber components other than the above polybutadiene include other polybutadienes and also other diene rubbers, such as styrene-butadiene rubber, natural rubbers, isoprene rubbers and ethylene-propylene-diene rubber.

Examples of co-crosslinking agents include unsaturated carboxylic acids and the metal salts of unsaturated carboxylic acids. Specific examples of unsaturated carboxylic acids include acrylic acid, methacrylic acid, maleic acid and fumaric acid. The use of acrylic acid or methacrylic acid is especially preferred. Metal salts of unsaturated carboxylic acids include, without particular limitation, the above unsaturated carboxylic acids that have been neutralized with desired metal ions. Specific examples include the zinc salts and magnesium salts of methacrylic acid and acrylic acid. The use of zinc acrylate is especially preferred.

The unsaturated carboxylic acid and/or metal salt thereof is included in an amount, per 100 parts by weight of the base rubber, which is preferably at least 5 parts by weight, more preferably at least 10 parts by weight, and even more preferably at least 15 parts by weight. The amount included is preferably not more than 60 parts by weight, more preferably not more than 50 parts by weight, and even more preferably not more than 45 parts by weight. Too much may make the core too hard, giving the ball an unpleasant feel at impact, whereas too little may lower the rebound.

The organic peroxide may be a commercially available product, specific examples of which include those available under the trade names Percumyl D, Perhexa 3M, Perhexa C-40, Niper BW and Peroyl L (all from NOF Corporation), and Luperco 231XL (from Atochem Co.). The use of one of these alone is preferred.

The amount of organic peroxide included per 100 parts by weight of the base rubber is preferably at least 0.1 part by weight, more preferably at least 0.3 part by weight, even more preferably at least 0.5 part by weight, and most preferably at least 0.7 part by weight. The upper limit is preferably not more than 5 parts by weight, more preferably not more than 4 parts by weight, even more preferably not more than 3 parts by weight, and most preferably not more than 2 parts by weight. When too much or too little is included, it may not be possible to obtain a ball having a good feel, durability and rebound.

Examples of preferred inert fillers include zinc oxide, barium sulfate and calcium carbonate. These may be used singly or as a combination of two or more thereof.

The amount of inert filler included per 100 parts by weight of the base rubber is preferably at least 1 part by weight, and more preferably at least 5 parts by weight. The upper limit in the amount included is preferably not more than 100 parts by weight, more preferably riot more than 80 parts by weight, and even more preferably not more than 60 parts by weight. Too much or too little inert filler may make it impossible to obtain a suitable weight and a good rebound.

In addition, an antioxidant may be optionally included. Illustrative examples of suitable commercial antioxidants include Nocrac NS-6, Nocrac NS-30 and Nocrac 200 (all available from Ouchi Shinko Chemical industry Co., Ltd.), and Yoshinox 425 (available from Yoshitomi Pharmaceutical Industries, Ltd.). These may be used singly or as a combination of two or more thereof.

The amount of antioxidant included can be set to more than 0, and may be set to an amount per 100 parts by weight of the base rubber which is preferably at least 0.05 part by weight, and more preferably at least 0.1 part by weight. The maximum amount included, although not subject to any particular limitation, may be set to an amount per 100 parts by weight of the base rubber which is preferably not more than 3 parts by weight, more preferably not more than 2 parts by weight, even more preferably not more than 1 part by weight, and most preferably not more than 0.5 part by weight. Too much or too little antioxidant may make it impossible to achieve a suitable core hardness gradient, a good rebound and durability, and a good spin rate-lowering effect on full shots.

An organosulfur compound may be optionally included in the rubber composition in order to enhance the core resilience. In cases where an organosulfur compound is included, the content thereof per 100 parts by weight of the base rubber may be set to preferably at least. 0.05 part by weight, and more preferably at least 0.1 part by weight. The upper limit in the organosulfur compound content may be set to preferably not more than 5 parts by weight, more preferably not more than 4 parts by weight, and even more preferably not more than 2 parts by weight. Including too little organosulfur compound may make it impossible to obtain a sufficient core rebound-increasing effect. On the other hand, when too much is included, the core hardness may become too low, worsening the feel of the ball at impact, and the durability of the ball to cracking on repeated impact may worsen.

The core may be formed of a material molded under heat from a rubber composition which includes as the essential ingredients: (I) a base rubber, (II) an organic peroxide, and (III) water and/or a metal monocarboxylate.

In the golf ball of the invention, as will be subsequently described, all or some portion of a surface of at least one core or cover layer of the golf ball is treated with a specific treatment solution. The layer treated with this treatment solution or a layer adjoining the treated layer is preferably formed of a material molded under heat from a rubber composition which includes the foregoing components I to III.

That is, by forming the core of a material molded under heat from a rubber composition which includes (I) a base rubber, (II) an organic peroxide, and (III) water and/or a metal monocarboxylate, the difference in crosslink density between the center and surface of the core and the dynamic viscoelastic properties in the center portion of the core can be suitably controlled, making it possible to provide a golf ball which achieves a lower spin rate, is endowed with a good durability, and moreover undergoes little change in rebound even with long-term use.

Also, decomposition of the organic peroxide within the core formulation can be promoted by the direct addition of water (or a water-containing material) to the core material. Moreover, it is known that the decomposition efficiency of the organic peroxide within the core-forming rubber composition changes with temperature and that, starting at a given temperature, the decomposition efficiency rises with increasing temperature. If the temperature is too high, the amount of decomposed radicals rises excessively, leading to recombination between radicals and, ultimately, deactivation. As a result, fewer radicals act effectively in crosslinking. Here, when a heat of decomposition is generated by decomposition of the organic peroxide at the time of core vulcanization, the vicinity of the core surface remains at substantially the same temperature as the temperature of the vulcanization mold, but the temperature near the core center, due to the build-up of heat of decomposition by the organic peroxide which has decomposed from the outside, becomes considerably higher than the mold temperature. In cases where water (or a water-containing material) is added directly to the core, because the water acts to promote decomposition of the organic peroxide, radical reactions like those described above can be made to differ in the core center and at the core surface. That is, decomposition of the organic peroxide is further promoted near the center of the core, bringing about greater radical deactivation, which leads to a further decrease in the amount of active radicals. As a result, it is possible to obtain a core in which the crosslink densities at the core center and the core surface differ markedly. It is also possible to obtain a core having different dynamic viscoelastic properties at the core center.

When zinc monoacrylate is used instead of the above water, water is generated from the zinc monoacrylate by heat during mixing of the compounding materials. An effect similar to that obtained by the addition of water can thereby be obtained.

Base rubbers and organic peroxides of the same types as those mentioned earlier may be advantageously used as the base rubber and the organic peroxide serving as components I and II.

The water serving as component III is not particularly limited, and may be distilled water or tap water. The use of distilled water which is free of impurities is especially preferred. The amount of water included per 100 parts by weight of the base rubber is preferably at least 0.1 part by weight, and more preferably at least 0.3 part by weight. The upper limit is preferably not more than 5 parts by weight, and more preferably not more than 4 parts by weight.

By including a suitable amount of such water, the moisture content in the rubber composition prior to vulcanization becomes preferably at least 1,000 ppm, and more preferably at least 1,500 ppm. The upper limit is preferably not more than 8,500 ppm, and more preferably not more than 8,000 ppm. When the moisture content of the rubber composition is too low, it may be difficult to obtain a suitable crosslink density and tan δ, which may make it difficult to mold a golf ball having little energy loss and a reduced spin rate. On the other hand, when the moisture content of the rubber composition is too high, the core may be too soft, which may make it difficult to obtain a suitable core initial velocity.

It is also possible to add water directly to the rubber composition. The following methods (i) to (iii) may be employed to include water:
(i) applying water in the form of a mist, as steam or by means of ultrasound, to some or all of the rubber composition (compounded material);
(ii) immersing some or all of the rubber composition in water;
(iii) letting some or all of the rubber composition stand for a given period of time in a high-humidity environment in a place where the humidity can be controlled, such as a constant humidity chamber.

The “high-humidity environment” is not particularly limited, so long as it is an environment capable of moistening the rubber composition, although a humidity of from 40 to 100% is preferred.

Alternatively, the water may be worked into a jelly state and added to the above rubber composition. Or a material obtained by first supporting water on a filler, unvulcanized rubber, rubber powder or the like may be added to the rubber composition. In such a form, the workability is better than when water is directly added to the composition, enabling the efficiency of golf ball production to be enhanced. The type of material in which a given amount of water has been included, although not particularly limited, is exemplified by fillers, unvulcanized rubbers and rubber powders in which sufficient water has been included. The use of a material which undergoes no loss of durability or resilience is especially preferred. The moisture content of the above material is preferably at least 3 wt %, more preferably at least 5 wt %, and even more preferably at least 10 wt %. The upper limit is preferably not more than 99 wt %, and even more preferably not more than 95 wt %.

In this invention, a metal monocarboxylate may be used instead of the above-described water. Metal monocarboxylates, in which the carboxylic acid is presumably coordination-bonded to the metal, are distinct from metal dicarboxylates such as zinc diacrylate of the formula (CH₂═CHCOO)₂Zn, in which two carboxylic acid molecules are bonded to a single metal atom. A metal monocarboxylate introduces water into the rubber composition by way of a dehydration/condensation reaction, and thus provides an effect similar to that of water. Moreover, because a metal monocarboxylate can be added to the rubber composition as a powder, the operations can be simplified and uniform dispersion within the rubber composition is easy. In order to carry out the above reaction effectively, a monosalt is required. The amount of metal monocarboxylate included per 100 parts by weight of the base rubber is preferably at least 1 part by weight, and more preferably at least 3 parts by weight. The upper limit in the amount of metal monocarboxylate included is preferably not more than 60 parts by weight, and more preferably not more than 50 parts by weight. When the amount of metal monocarboxylate included is too small, it may be difficult to obtain a suitable crosslink density and tan δ, as a result of which a sufficient golf ball spin rate-lowering effect may not be achievable. On the other hand, when too much is included, the core may become too hard, as a result of which it may be difficult for the ball to maintain a suitable feel at impact.

The carboxylic acid used may be, for example, acrylic acid, methacrylic acid, maleic acid, fumaric acid or stearic acid. Examples of the substituting metal include sodium, potassium, lithium, zinc, copper, magnesium, calcium, cobalt, nickel and lead, although the use of zinc is preferred. Illustrative examples of the metal monocarboxylate include zinc monoacrylate and zinc monomethacrylate, with the use of zinc monoacrylate being especially preferred.

The rubber composition containing the various above ingredients is prepared by mixture using a typical mixing apparatus, such as a Banbury mixer or a roll mill. When this rubber composition is used to mold the core, molding may be carried out by compression molding or injection molding using a specific mold for molding cores. The resulting molded body is then heated and cured under temperature conditions sufficient for the organic peroxide and co-crosslinking agent included in the rubber composition to act, thereby giving a core having a specific hardness profile. The vulcanization conditions in this case, while not subject to any particular limitation, are generally set to a temperature of from about 130 to about 170° C., and especially 150 to 160° C., and a time of from 10 to 40 minutes, and especially 12 to 20 minutes.

Next, the cover used in the inventive golf ball is described. The cover is a member that encases the core and is composed of at least one layer. Exemplary covers include two-layer covers and three-layer covers. In the case of a two-layer cover, the inner layer is referred to as the intermediate layer and the outer layer is referred to as the outermost layer. In the case of a three-layer cover, the respective layers are referred to, in order from the inside: the envelope layer, the intermediate layer and the outermost layer.

Known resins may be used without particular limitation as the resin materials which form the cover. Use can be made of one, two or more resins selected from the group consisting of ionomer resins, and urethane-, amide-, ester-, olefin- and styrene-based thermoplastic elastomers.

The ionomer resin is not subject to any particular limitation, and may be a known product. Commercial products that may be used as the ionomer resin include, for example, H1706, H1605, H1557, H1601, AM7329, AM7317 and AM7318, all of which are available from DuPont-Mitsui Polychemicals Co.

Thermoplastic elastomers are exemplified by polyester elastomers, polyamide elastomers and polyurethane elastomers. The use of a polyurethane elastomer is especially preferred.

The polyurethane elastomer is not particularly limited, provided it is an elastomer composed primarily of polyurethane. A morphology that includes soft segments composed of a high-molecular-weight polyol compound and hard segments composed of a diisocyanate and a monomolecular chain extender is preferred.

Exemplary polymeric polyol compounds include, but are not particularly limited to, polyester polyols and polyether polyols. From the standpoint of rebound resilience or low-temperature properties, the use of a polyether polyol is preferred. Examples of polyether polyols include polytetramethylene glycol and polypropylene glycol, with the use of polytetramethylene glycol being especially preferred. These polyether polyols have a number-average molecular weight of preferably from 1,000 to 5,000, and more preferably from 1,500 to 3,000.

Exemplary diisocyanates include, but are not particularly limited to, aromatic diisocyanates such as 4,4′-diphenylmethane diisocyanate, 2,4-toluene diisocyanate and 2,6-toluene diisocyanate; and aliphatic diisocyanates such as hexamethylene diisocyanate. In the practice of this invention, from the standpoint of reaction stability with the subsequently described isocyanate mixture when blended therewith, the use of 4,4′-diphenylmethane diisocyanate is preferred.

The monomolecular chain extender is not particularly limited, although use can be made of an ordinary polyol or polyamine. Specific examples include 1,4-butylene glycol, 1,2-ethylene glycol, 1,3-propylene glycol, 1,3-butanediol, 1,6-hexylene glycol, 2,2-dimethyl-1,3-propanediol, 1,3-butylene glycol, dicyclohexylmethylmethanediamine (hydrogenated MDA) and isophoronediamine (IPDA). These chain extenders have average molecular weights of preferably from 20 to 15,000.

A commercial product may be used as the polyurethane elastomer. Illustrative examples include Pandex T7298, TR3080, T8230, T8290, T8295 and T8260 (all available from DIC Bayer Polymer, Ltd.), and Resamine 2593 and 2597 (available from Dainichiseika Color & Chemicals Mfg. Co., Ltd.). These may be used singly, or two or more may be used in combination.

The material which forms the cover is exemplified by a resin composition containing as the essential components:
100 parts by weight of a resin component composed of, in admixture,

(e) a base resin of (e-1) an olefin-unsaturated carboxylic acid random copolymer and/or a metal ion neutralization product of an olefin-unsaturated carboxylic acid random copolymer mixed with (e-2) an olefin-unsaturated carboxylic acid-unsaturated carboxylic acid ester random terpolymer and/or a metal ion neutralization product of an olefin-unsaturated carboxylic acid-unsaturated carboxylic acid ester random terpolymer in a weight ratio between 100:0 and 0:100, and

(f) a non-ionomeric thermoplastic elastomer in a weight ratio between 100:0 and 50:50;

(g) from 5 to 120 parts by weight of a fatty acid and/or fatty acid derivative having a molecular weight of from 228 to 1,500; and

(h) from 0.1 to 17 parts by weight of a basic inorganic metal compound capable of neutralizing un-neutralized acid groups in components (e) and (g).

In this invention, to more fully exhibit the desired effects of the invention, it is preferable to use a resin material containing above components (e) and (f) in the layer treated with a specific treatment solution or in a layer adjoining the treated layer. The use of a resin material containing all of the above ingredients (e), (f), (g) and (h) is more preferred.

Components A to D in the resin material described in, for example, JP-A 2011-120898 may be advantageously used as above components (e) to (h).

Various additives may be optionally included in the cover-forming material. For example, pigments, dispersants, antioxidants, light stabilizers, ultraviolet, absorbers and internal mold lubricants may be suitably included.

A known method may be used without particular limitation as the method of forming the layers of the cover. For example, use may be made of a method in which a pre-fabricated core or a sphere encased by any of the various layers is placed in a mold, and the resin material prepared as described above is inlection-molded over the core or layer-encased sphere. In addition, a layer of paint may be applied to the surface of the outermost layer of this cover.

In the golf ball of the invention, some or all of a surface of at least one core or cover layer of the ball is treated with a treatment solution which includes:
(A) a polyolefin-based thermoplastic resin, and
(B) at least one solvent selected from the group consisting of (b-1) water, (b-2) ammonia water and (b-3) organic solvents,
   and is obtained by dissolving or finely dispersing resin solids of component A in the solvent of component B.

A common olefin resin or ionomer resin may be used as the polyolefin-based thermoplastic resin of component A. It is especially suitable to use at least one resin component selected from the group consisting of:

(a-1) copolymers of an olefin and an α,β-unsaturated carboxylic acid of 3 to 8 carbon atoms,

(a-2) ionomer resins consisting of a metal ion neutralization product of a copolymer of an olefin and an α,β-unsaturated carboxylic acid of 3 to 8 carbon atoms,

(a-3) terpolymers of an olefin, an α,β-unsaturated carboxylic acid of 3 to 8 carbon atoms and an α,β-unsaturated carboxylic acid ester, and

(a-4) ionomer resins consisting of a metal ion neutralization product of a terpolymer of an olefin, an α,β-unsaturated carboxylic acid of 3 to 8 carbon atoms and an α,β-unsaturated carboxylic acid ester.

The olefin in the above resin components is preferably ethylene or propylene. Illustrative examples of the α,β-unsaturated carboxylic acid include acrylic acid, methacrylic acid, fumaric acid, maleic acid and crotonic acid, with acrylic acid and methacrylic acid being especially preferred, and a higher acid content being more preferable. Illustrative examples of the α,β-unsaturated carboxylic acid ester include methyl, ethyl, propyl, n-butyl and isobutyl esters of acrylic acid, methacrylic acid, fumaric acid and maleic acid, with acrylic acid esters and methacrylic acid esters being especially preferred. Illustrative examples of the metal ions in the metal ion neutralization products of these copolymers include Na⁺, Zn⁺⁺, Ca⁺⁺, Mg⁺⁺, Al⁺⁺⁺ and Nd⁺⁺⁺. From the standpoint of achieving a fine dispersion, alkali metals such as Na⁺, K⁺ and Li⁺ are preferred.

Commercial products may be used as above component (a-1). Illustrative examples include Nucrel® N1560, N1214, N1035 and AN4221C (all products of DuPont-Mitsui Polychemicals Co., Ltd.), and Escor™ 5200, 5100 and 5000 (all products of ExxonMobil Chemical).

Commercial products may be used as above component (a-2). Illustrative examples include Himilan® 1605, 1707 and AM7318 (all products of DuPont-Mitsui Polychemicals Co., Ltd.), Surlyn® 8940, 8920 and 8150 (all products of E.I. DuPont de Nemours & Co.), Iotek® 8000 (Exxonmobil Chemical), and AMPLIFY™ IO 3801 and 3802 (both from Dow Chemical Company).

Commercial products may be used as above component (a-3). Illustrative examples include Nucrel® AN4311, AN4318 and AN4319 (all products of DuPont-Mitsui Polychemicals Co., Ltd.), and Escor™ ATX320 and ATX310 (both from ExxonMobil Chemical).

Commercial products may be used as above component (a-4). Illustrative examples include Himilan® 1855 and AN7331 (both products of DuPont-Mitsui Polychemicals Co., Ltd.), and Surlyn® 8320 and 8120 (both products of E.I. DuPont de Nemours & Co.).

Component B is at least one solvent selected from the group consisting of (b-1) water, (b-2) ammonia water, and (b-3) organic solvents.

The water (b-1) is not particularly limited, and may be distilled water or tap water, although the use of distilled water containing no impurities is especially preferred. The organic solvent (b-3), from the standpoint of hydrophilicity, is preferably a polar solvent. Although not particularly limited, the organic solvent is preferably selected from the group consisting of methanol, ethanol, n-propanol, isopropyl alcohol, acetone, tetrahydrofuran, ethylene glycol, dioxane, methyl ethyl ketone, acetic acid, ethyl acetate and chloroform.

The treatment solution used in this invention is in a state where the resin solids of component A have been dissolved in or finely dispersed with the solvent of component B. The particle size of the finely dispersed resin solids of component (A) is preferably not more than 10 μm, and especially from 0.01 to 3 μm. The numerical values for the particle size are based on the Coulter counter method.

The pH of this treatment solution, although not particularly limited, is preferably set to an alkalinity of 7.5 or more, and especially 8.0 or more. A stronger alkalinity tends to result in a smaller particle size for the resin solids, enabling the particles to be rendered into a state suitable for fine dispersion.

The concentration of component A resin solids in the treatment solution is preferably from 0.1 to 50 wt %. When the concentration of resin solids is too high, a finely dispersed state is not sufficiently achieved, as a result of which surface treatment may become impossible. On the other hand, when the concentration of resin solids is too low, an adhesive effect may not be obtained.

As mentioned above, the treatment solution is a combination of specific resin solids (component A) and a solvent (component B). Commercial products may be used as the respective components, or commercially available dispersions made up of components A and B may be used. Illustrative examples of commercial dispersions include the following from Mitsui Chemical, Inc.: Chemipearl™ S-100, Chemipearl™ S-120, Chemipearl™ S-300, Chemipearl™ S-75N, and Unistole™ P-401 and Unistole™ R-100K.

Examples of surface treatment methods with the above treatment solution include methods in which the treatment solution is applied to the core surface or the surface of any of various layers by brush coating, roller coating or spraying, or by painting with an air sprayer or a roller coater, and methods in which the core or a sphere encased by any of various layers is dipped directly in the treatment solution. From the standpoint of productivity and efficiency of pick-up onto the core surface, the use of a dipping method is especially preferred. When a dipping method is used, the dipping time is preferably from 5 to 60 seconds and the dipping temperature is preferably from 10 to 40° C.

Using the treatment solution, resin solids (component A) within the solution can be deposited on the surface of the core or a sphere encased by any of various layers, although this depends also on such factors as the method of treatment with the treatment solution. The pick-up of resin solids is preferably at least 0.001 g, more preferably at least 0.005 g, and even more preferably at least 0.01 g, and is preferably not more than 0.3 g, more preferably not more than 0.2 g, and even more preferably not more than 0.1.

Following pick-up of the treatment solution, a drying step to effect thorough drying may be suitably provided as a subsequent step.

In this invention, by thus treating the surface of the core or any of various layers with the specific treatment solution described above, adhesion between these layers is enhanced. Specifically, the bond strength, as measured by the subsequently described method, can be set to preferably at least 1.10 N/4 mm, and more preferably at least 1.20 N/4 mm.

### EXAMPLES

The following Examples and Comparative Examples are provided to illustrate the invention, and are not intended to limit, the scope thereof.

### Examples 1 to 15, Comparative Examples 1 to 6

### Core Formation

Cores for the respective Examples of the invention and Comparative Examples were produced by preparing the rubber compositions shown in Table 1 below, then molding and vulcanizing the compositions under vulcanization conditions of 157° C. and 15 minutes.

TABLE 1

Core formulation

| (parts by weight) | A | B |
|---|---|---|
| Polybutadiene I | 80 | 80 |
| Polybutadiene II | 20 | 20 |
| Zinc acrylate | 34.5 | 41.0 |
| Zinc oxide | 4.0 | 4.0 |
| Barium sulfate | 19.4 | 16.8 |
| Antioxidant | 0.1 | 0.1 |
| Organic peroxide | 1.0 | 1.0 |
| Zinc salt of pentachlorothiophenol | 0.3 | 0.3 |
| Water | 0.4 | 1.0 |

Details on the rubber compositions shown in Table 1 are given below.
Polybutadiene I: Available as “BR 01” from JSR Corporation
Polybutadiene II: Available as “BR 51” from JSR Corporation
Zinc acrylate: Available from Nihon Jyoryu Co., Ltd.
Zinc oxide: Available from Sakai Chemical Co., Ltd.
Barium sulfate: Available as “Precipitated Barium Sulfate 100″ from Sakai Chemical Co., Ltd.
Antioxidant: Available as “Nocrac NS-6” from Ouchi Shinko Chemical Industry Co., Ltd.
Organic peroxide: Dicumyl peroxide, available as “Percumyl D” from NOR Corporation
Water: Distilled water

Next, in each of Examples 1 to 15 of the invention, the olefin-based thermoplastic resin-containing treatment solutions shown in Tables 3 and 4 were applied to the core surface by dipping the core in the solution at room temperature (27° C.) for the dipping time shown in the same table, then thoroughly dried.

### [Core Surface Treatment Solution]

Details on the treatment solutions shown in Tables 3 and 4 are given below.
(A-1) Olefinic thermoplastic resin-containing solution: Aqueous dispersion of an ionomer, available from Mitsui Chemical. Inc. as Chemipearl™ S-100 (solids concentration, 27 wt %; particle size, <0.1 μm)
(A-II) Olefinic thermoplastic resin-containing solution: Aqueous dispersion of an ionomer, available from Mitsui Chemical. Inc. as Chemipearl™ S-120 (solids concentration, 27 wt %; particle size, <0.1 μm)
(A-III) Olefinic thermoplastic resin-containing solution: Aqueous dispersion of an ionomer, available from Mitsui Chemical. Inc. as Chemipearl™ S-300 (solids concentration, 35 wt %; particle size, 0.5 μm)
(A-IV) Olefinic thermoplastic resin-containing solution: Aqueous dispersion of an un-neutralized olefin resin, available from Mitsui Chemical. Inc. as Chemipearl™ S-75N (solids concentration, 24 wt %; particle size, <0.1 μm)
(A-1) Olefinic thermoplastic resin: Un-neutralized ethylene-acrylic acid copolymer, available from DuPont-Mitsui Polychemicals Co., Ltd. as Nucrel® AN4221C
Butyl rubber: “Butyl 1365” from JSR Corporation
Water-soluble polymer-containing solution:
A water-soluble polymer containing isoprene sulfonic acid as is the structural unit (“Dynaflow CS2111” from JSR Corporation)

### [Solvent]

Water: Distilled water
Ethanol: Guaranteed reagent grade ethanol from Kanto Chemical Co., Ltd.
Chloroform: Guaranteed reagent, grade chloroform from Kanto Chemical Co., Ltd.
Tetrahydrofuran: Guaranteed reagent grade tetrahydrofuran from Kanto Chemical Co., Ltd.

Next, in each Example, an envelope layer, an intermediate layer and an outermost layer were successively formed over the periphery of the core surface by injection-molding the respective resin formulations shown in Table 2, thereby producing a multi-piece solid golf ball.

TABLE 2

| Formulation (pbw) | No. 1 | No. 2 | No. 3 |
|---|---|---|---|
| HPF 1000 | 100 | | |
| Himilan 1605 | | 50 | |
| Himilan 1706 | | 35 | |
| Himilan 1557 | | 15 | |
| Trimethylolpropane | | 1.1 | |
| T-8283 | | | 62.5 |
| T-8290 | | | 37.5 |
| Titanium oxide | | | 3.5 |
| Ultramarine | | | 0.4 |
| Polyethylene wax | | | 1 |

Details on the resin compositions shown in Table 2 are given below.
HPF 1000: An ionomer available from E.I. DuPont de Nemours & Co.
Himilan: monomers available from DuPont-Mitsui Polychemicals Co., Ltd.
T-8283: A MDI-PTMG type thermoplastic polyurethane available under the trade name “Pandex” from DIC Bayer Polymer; JIS-A hardness, 83
T-8290: A MDI-PTMG type thermoplastic polyurethane available under the trade name “Pandex” from DIC Bayer Polymer; JIS-A hardness, 93
Polyethylene wax: Available under the trade name “Sanwax 161P” from Sanyo Chemical Industries, Ltd.

The bond strengths and durability on impact of the resulting golf balls were evaluated as described below. The results are shown in Tables 3 and 4.

### Bond Strength

Referring to FIG. 1, in a sphere composed of a core 1 encased by an envelope layer 2, two parallel cuts 11, 12 spaced 4.0 mm apart were made in the envelope layer 2 in such a way as to pass entirely through this layer, and the envelope layer 2 at both ends of the sphere was peeled off. Next, a lateral cut 13 that passes entirely through the envelope layer 2 was made at a right angle to the first two cuts 11, 12, after which the bond strength was measured by immobilizing the core portion 1 and pulling on the cut end of the envelope layer 2. Measurement was carried out using an Instron tester and based on JIS K6256 (“Adhesion Test Method for Vulcanized Rubber and Thermoplastic Rubber”). Using the specially prepared test specimen described above, the clamp was moved at a speed of 50 mm/min and the tensile strength was measured at 0.1 mm intervals. The average of the tensile strengths for three test specimens, after discarding the first quarter and the last quarter of all the measurement points, was treated as the bond strength (units: N).

### Durability on Impact

The durability of the golf ball was evaluated using an ADC Ball COR Durability Tester produced by Automated Design Corporation (U.S.). This tester fires a golf ball pneumatically and causes it to repeatedly strike two metal plates arranged in parallel. The incident velocity against the metal plates was set at 43 m/s and the number of shots required for the golf ball to crack was measured. Durability values for the balls in the respective examples were calculated relative to an arbitrary index of 100 for the average number of shots taken with the ball obtained in Example 10 (n=5). The durabilities of the balls were rated based on the following criteria, giving the results shown in Table 3.

Good: Durability value was 95 or more

NG: Durability value was less than 95

TABLE 3

| | | | Example | | | | | | | | | |
|---|---|---|---|---|---|---|---|---|---|---|---|---|
| | | | 1 | 2 | 3 | 4 | 5 | 6 | 7 | 8 | 9 | 10 |
| Construction | | | 4- | 4- | 4- | 4- | 4- | 4- | 4- | 4- | 4- | 4- |
| | | | piece | piece | piece | piece | piece | piece | piece | piece | piece | piece |
| Core | Rubber formulation | | A | A | A | A | A | A | A | A | A | A |
| | Surface | Olefinic | 100 | 50 | | | | | | | | |
| | treatment | thermoplastic | | | | | | | | | | |
| | solution | resin-containing | | | | | | | | | | |
| | | solution (A-I) | | | | | | | | | | |
| | | Olefinic | | | 100 | 50 | | | | | | |
| | | thermoplastic | | | | | | | | | | |
| | | resin-containing | | | | | | | | | | |
| | | solution (A-II) | | | | | | | | | | |
| | | Olefinic | | | | | 100 | 50 | | | | |
| | | thermoplastic | | | | | | | | | | |
| | | resin-containing | | | | | | | | | | |
| | | solution (A-III) | | | | | | | | | | |
| | | Olefinic | | | | | | | 100 | 50 | | |
| | | thermoplastic | | | | | | | | | | |
| | | resin-containing | | | | | | | | | | |
| | | solution (A-IV) | | | | | | | | | | |
| | | Olefinic | | | | | | | | | 2 | 2 |
| | | thermoplastic | | | | | | | | | | |
| | | resin (A-1) | | | | | | | | | | |
| | | Butyl rubber | | | | | | | | | | |
| | | Water-soluble | | | | | | | | | | |
| | | polymer-containing | | | | | | | | | | |
| | | solution | | | | | | | | | | |

| | | | | | | | |
|---|---|---|---|---|---|---|---|
| Solvent | Water | 50 | 50 | 50 | 50 | | |
| | Ethanol | | | | | | |
| | Chloroform | | | | | | |
| | Tetrahydro- | | | | | 98 | 98 |
| | furan | | | | | | |

| | | Content of rubber, | 27.0 | 13.5 | 27.0 | 13.5 | 27.0 | 13.5 | 24.0 | 12.0 | 2.0 | 2.0 |
|---|---|---|---|---|---|---|---|---|---|---|---|---|
| | | water-soluble | | | | | | | | | | |
| | | polymer or olefinic | | | | | | | | | | |
| | | thermoplastic resin | | | | | | | | | | |
| | | (wt %) | | | | | | | | | | |
| | | Treatment | 10 | 10 | 10 | 10 | 10 | 10 | 9 | 9 | — | — |
| | | solution pH | | | | | | | | | | |
| | | Pickup (g) | 0.022 | 0.017 | 0.022 | 0.016 | 0.02 | 0.016 | 0.023 | 0.017 | 0.012 | 0.015 |
| | Conditions | Dipping time | 30 | 30 | 30 | 30 | 30 | 30 | 30 | 30 | 30 | 60 |
| | | (sec) | | | | | | | | | | |
| | | Treatment | RT | RT | RT | RT | RT | RT | RT | RT | RT | RT |
| | | temperature (° C.) | | | | | | | | | | |
| Cover | Envelope | Resin | No. 1 | | | | | | | | | |
| | layer | formulation | | | | | | | | | | |
| | Intermediate | Resin | No. 2 | | | | | | | | | |
| | layer | formulation | | | | | | | | | | |
| | Outermost | Resin | No. 3 | | | | | | | | | |
| | layer | formulation | | | | | | | | | | |
| Ball | Peel value (N/4 mm) | | 1.94 | 1.90 | 2.06 | 1.67 | 2.36 | 2.27 | 5.11 | 4.19 | 1.53 | 1.67 |
| properties | Durability | Durability | 131 | 125 | 128 | 114 | 133 | 117 | 125 | 110 | 115 | 100 |
| | at impact | index | | | | | | | | | | |
| | | Rating | good | good | good | good | good | good | good | good | good | good |

The numbers given for the core surface treatment solution indicate ingredient contents (%) within the solution.
RT = room temperature

TABLE 4

| | | | Example | | | | | Comparative Example | | | | | |
|---|---|---|---|---|---|---|---|---|---|---|---|---|---|
| | | | 11 | 12 | 13 | 14 | 15 | 1 | 2 | 3 | 4 | 5 | 6 |
| Construction | | | 4- | 4- | 4- | 4- | 4- | 4- | 4- | 4- | 4- | 4- | 4- |
| | | | piece | piece | piece | piece | piece | piece | piece | piece | piece | piece | piece |
| Core | Rubber formulation | | B | B | B | B | B | A | A | A | A | B | B |
| | treatment | Olefinic | 50 | 25 | 10 | 10 | 5 | | | | | | |
| | solution | thermoplastic | | | | | | | | | | | |
| | | resin-containing | | | | | | | | | | | |
| | | solution (A-I) | | | | | | | | | | | |
| | | Olefinic | | | | | | | | | | | |
| | | thermoplastic | | | | | | | | | | | |
| | | resin-containing | | | | | | | | | | | |
| | | solution (A-II) | | | | | | | | | | | |
| | | Olefinic | | | | | | | | | | | |
| | | thermoplastic | | | | | | | | | | | |
| | | resin-containing | | | | | | | | | | | |
| | | solution (A-III) | | | | | | | | | | | |
| | | Olefinic | | | | | | | | | | | |
| | | thermoplastic | | | | | | | | | | | |
| | | resin-containing | | | | | | | | | | | |
| | | solution (A-IV) | | | | | | | | | | | |
| | | Olefinic | | | | | | | | | | | |
| | | thermoplastic | | | | | | | | | | | |
| | | resin (A-1) | | | | | | | | | | | |
| | | Butyl rubber | | | | | | | 2 | | | | |
| | | Water-soluble | | | | | | | | 100 | 50 | | |
| | | Polymer-containing | | | | | | | | | | | |
| | | solution | | | | | | | | | | | |

| | | | | | | | | | |
|---|---|---|---|---|---|---|---|---|---|
| Solvent | Water | 50 | 75 | 90 | 45 | 47.5 | | 50 | 100 |
| | Ethanol | | | | 45 | 47.5 | | | |
| | Chloroform | | | | | | 98 | | |
| | Tetrahydro- | | | | | | | | |
| | furan | | | | | | | | |

| | | Content of rubber, | 13.5 | 6.8 | 2.7 | 2.7 | 1.4 | 0 | 2.0 | 40.0 | 20.0 | 0 | |
|---|---|---|---|---|---|---|---|---|---|---|---|---|---|
| | | water-soluble | | | | | | | | | | | |
| | | polymer or olefinic | | | | | | | | | | | |
| | | thermoplastic resin | | | | | | | | | | | |
| | | (wt %) | | | | | | | | | | | |
| | | Treatment | 10 | 9 | 9 | 9 | 9 | — | — | 4 | 4 | — | 7 |
| | | solution pH | | | | | | | | | | | |
| | | Pickup (g) | 0.018 | 0.014 | 0.01 | 0.012 | 0.009 | 0 | 0.028 | 0.042 | 0.029 | 0 | 0 |
| | Conditions | Dipping time | 30 | 30 | 30 | 30 | 30 | — | 60 | 30 | 30 | — | 30 |
| | | (sec) | | | | | | | | | | | |
| | | Treatment | RT | RT | RT | RT | RT | — | RT | RT | RT | — | RT |
| | | temperature (° C.) | | | | | | | | | | | |
| Cover | Envelope | Resin | No. 1 | | | | | No. 1 | | | | | |
| | layer | formulation | | | | | | | | | | | |
| | Intermediate | Resin | No. 2 | | | | | No. 2 | | | | | |
| | layer | formulation | | | | | | | | | | | |
| | Outermost | Resin | No. 3 | | | | | No. 3 | | | | | |
| | layer | formulation | | | | | | | | | | | |
| Ball | Peel value (N/4 mm) | | 1.61 | 1.53 | 1.38 | 1.53 | 1.21 | 1.01 | 0.48 | 0.69 | 0.63 | 0.96 | 1.02 |
| properties | Durability | Durability | 110 | 108 | 101 | 108 | 104 | 91 | 62 | 33 | 33 | 70 | 72 |
| | at impact | index | | | | | | | | | | | |
| | | Rating | good | good | good | good | good | NG | NG | NG | NG | NG | NG |

The numbers given for the core surface treatment solution indicate ingredient contents (%) within the solution.
RT = room temperature

The test results in Tables 3 and 4 are discussed below.

Comparative Example 1 is an example of a four-piece golf ball in which the core surface was not treated. Adhesion between the core and the envelope layer (the adjoining layer) was inadequate, and so the durability on repeated impact was low.

Comparative Example 2 is an example of a four-piece golf ball which was treated by dipping in a butyl rubber solution. Adhesion between the core and the envelope layer (the adjoining layer) was inadequate, and so the durability on repeated impact was low.

Comparative Example 3 is an example of a four-piece golf ball which was treated by dipping in a solution containing a water-soluble polymer in which isoprene sulfonic acid serves as the structural unit. Adhesion between the core and the envelope layer (the adjoining layer) was inadequate, and so the durability on repeated impact was low.

Comparative Example 4 is an example of a four-piece golf ball which was treated by dipping in a solution which contained a water-soluble polymer in which isoprene sulfonic acid serves as the structural unit and which was additionally diluted with water. Adhesion between the core and the envelope layer (the adjoining layer) was inadequate, and so the durability on repeated impact was low.

Comparative Example 5 is an example of a four-piece golf ball in which the core surface was not treated. Adhesion between the core and the envelope layer (the adjoining layer) was inadequate, and so the durability on repeated impact was low.

Comparative Example 6 is an example of a four-piece golf ball in which the core surface was treated with water alone. Adhesion between the core and the envelope layer (the adjoining layer) was inadequate, and so the durability on repeated impact was low.

Japanese Patent Application No. 2015-104388 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A golf ball comprising a core of at least one layer and a cover of at least one layer, wherein some or all of a surface of at least one such layer of the ball is treated with a treatment solution comprising:
(A) a polyolefin-based thermoplastic resin, and
(B) at least one solvent selected from the group consisting of
(b-1) water,
(b-2) ammonia water, and
(b-3) organic solvents,
and obtained by dissolving or finely dispersing resin solids of component A in the solvent of component B.

2. The golf ball of claim 1, wherein the thermoplastic resin of component A is at least one resin selected from the group consisting of:
(a-1) copolymers of an olefin and an α,β-unsaturated carboxylic acid of 3 to 8 carbon atoms,
(a-2) ionomer resins consisting of a metal ion neutralization product of a copolymer of an olefin and an α,β-unsaturated carboxylic acid of 3 to 8 carbon atoms,
(a-3) terpolymers of an olefin, an α,β-unsaturated carboxylic acid of 3 to 8 carbon atoms and an α,β-unsaturated carboxylic acid ester, and
(a-4) ionomer resins consisting of a metal ion neutralization product of a terpolymer of an olefin, an α,β-unsaturated carboxylic acid of 3 to 8 carbon atoms and an α,β-unsaturated carboxylic acid ester.

3. The golf ball of claim 1, wherein the thermoplastic resin of component A is finely dispersed in the solvent of component B, and the finely dispersed component A resin has a particle size of not more than 10 μm.

4. The golf ball of claim 1, wherein the treatment solution has a pH of at least 7.5.

5. The golf ball of claim 1, wherein the layer treated with the treatment solution or a layer adjoining the treated layer is formed of a material molded under heat from a rubber composition comprising:
(I) a base rubber,
(II an organic peroxide, and
(III) water and/or a metal monocarboxylate.

6. The golf ball of claim 1, wherein the layer treated with the treatment solution or a layer adjoining the treated layer is formed primarily of a material obtained by blending as essential components:
100 parts by weight of a resin component comprising, in admixture,
(e) a base resin of (e-1) an olefin-unsaturated carboxylic acid random copolymer and/or a metal ion neutralization product of an olefin-unsaturated carboxylic acid random copolymer mixed with (e-2) an olefin-unsaturated carboxylic acid-unsaturated carboxylic acid ester random terpolymer and/or a metal ion neutralization product of an olefin-unsaturated carboxylic acid-unsaturated carboxylic acid ester random terpolymer in a weight ratio between 100:0 and 0:100, and
(f) a non-ionomeric thermoplastic elastomer in a weight ratio between 100:0 and 50:50;
(g) from 5 to 120 parts by weight of a fatty acid and/or fatty acid derivative having a molecular weight of from 228 to 1,500; and
(h) from 0.1 to 17 parts by weight of a basic inorganic metal compound capable of neutralizing un-neutralized acid groups in the base resin and component (g).

7. The golf ball of claim 1, wherein the layer treated with the treatment solution and the layer adjoining the treated layer have a bond strength therebetween of at least 1.10 N/4 mm.

8. The golf ball of claim 1, wherein the organic solvent (b-3) is a polar solvent.

9. The golf ball of claim 8, wherein the organic solvent (b-3) is selected from the group consisting of methanol, ethanol, n-propanol, isopropyl alcohol, acetone, tetrahydrofuran, ethylene glycol, dioxane, methyl ethyl ketone, acetic acid, ethyl acetate and chloroform.

10. The golf ball of claim 1, wherein the treatment solution has a concentration of component. A resin solids of from 0.1 to 50 wt %.
